(19) United States
(12) Patent Application Publication
(10) Pub. No.: US 2014/0216423 A1
(43) Pub. Date: Aug. 7, 2014

(54) EXHAUST SYSTEM PART, EGR COOLER, AND METHOD OF NITRIDING EXHAUST SYSTEM PART

(71) Applicants: Masahiko Mitsubayashi, Nagoya-shi (JP); Keisuke Kadota, Toyota-shi (JP)

(72) Inventors: Masahiko Mitsubayashi, Nagoya-shi (JP); Keisuke Kadota, Toyota-shi (JP)

(73) Assignee: TOYOTA JIDOSHA KABUSHIKI KAISHA, Toyota-shi, Aichi-ken (JP)

(21) Appl. No.: 13/521,315

(22) PCT Filed: May 26, 2011
(86) PCT No.: PCT/JP2011/002934

§ 371 Date: Jul. 10, 2012

(51) Int. Cl. F02M 25/07; F01N 3/10

(52) U.S. Cl. CPC F02M 25/0726; F01N 3/10
USPC 123/568.12; 60/299; 60/274

(57) ABSTRACT

Disclosed is an exhaust system part having a high corrosion resistance, an EGR cooler using the exhaust system part, and a method of nitriding the exhaust system part. The exhaust system part made of a stainless steel and having an exhaust gas of an internal combustion engine flow therein, includes an upstream side end portion through which the exhaust gas is introduced, a downstream side end portion through which the exhaust gas is discharged, and a wall portion formed in an annular shape extending in the direction of the exhaust gas flow and disposed between the upstream side end portion and the downstream side end portion, in which a chromium oxide nitride film consisting of CrOₓN_{y} is formed on the inner peripheral surface of the wall portion.

### TECHNICAL FIELD

The present invention relates to an exhaust system part to be used for an exhaust apparatus of a vehicle having an internal combustion engine mounted thereon, an EGR cooler using the exhaust system part, and a method of nitriding the exhaust system part, and more particularly to an exhaust system part capable of improving corrosion resistance, the EGR cooler using the exhaust system part, and the method of nitriding the exhaust system part.

### BACKGROUND ART

In general, the internal combustion engine (hereinafter simply referred to as engine) mounted on the vehicle such as automobiles and the like is constructed with an engine body, a suction apparatus, and an exhaust apparatus. The engine body is adapted to convert fuel to a driving power by burning the fuel with air. The suction apparatus is provided to suck the air and to supply the air to the engine body.

The exhaust apparatus is operative to discharge the exhaust gas into the atmosphere after the exhaust gas is generated by burning the fuel. The exhaust apparatus of this kind is constructed to include, for example, an exhaust manifold, a catalytic converter, a heat recovery unit, a muffler, and an exhaust pipe.

In recent years, there has been proposed an engine which is provided with an exhaust gas recirculation (simply referred to as EGR hereinafter) apparatus. The EGR apparatus is operative to extract a part of the exhaust gas discharged from the exhaust apparatus to be supplied to the suction apparatus, and then to be burned again in the engine body.

The EGR apparatus is constructed to include, for example, an EGR pipe and an EGR cooler. The EGR pipe is provided to have the exhaust apparatus connected to a suction apparatus. The EGR cooler is disposed on the longitudinally intermediate portion of the EGR pipe to cool the high temperature exhaust gas discharged from the exhaust apparatus, and then to be supplied to the suction apparatus.

Throughout the present specification, each of the parts to be held in contact with the exhaust gas such as components forming parts of the above mentioned exhaust apparatus and components forming parts of the EGR apparatus are simply referred to as exhaust system parts. The exhaust system part has an exhaust gas contact portion that is held in contact with the exhaust gas and an exposed portion that is held in contact with the atmosphere.

The exhaust gas contains a lot of water vapor and carbonic acid gas (CO₂), and further contains sulfurous acid gas (SO₂), nitrogen oxide (NOₓ), and other gases. As the exhaust gas at a high temperature is cooled, the water vapor in the exhaust gas is condensed to become condensed water, thereby generating dew condensation on exhaust contact portions of the exhaust system part.

As the sulfurous acid gas is dissolved in the condensed water, sulfuric acid (H₂SO₄) and sulfuric anhydride (SO₃) are generated. As nitrogen oxide is dissolved in the condensed water, nitric acid (HNO₃) is generated.

Although chlorine, in general, is not included in a gasoline as the fuel of the engine, the chlorine is sometimes included in the gasoline depending on the countries or regions. Moreover, the chlorine is included in the engine oil and the atmosphere. Therefore, the chlorine in the gasoline, the engine oil, and the atmosphere is mixed with the exhaust gas in the combustion chamber of the engine, and thus the chlorine is sometimes included in the exhaust gas. As chlorine in the exhaust gas is dissolved in the condensed water in the EGR cooler, hydrochloric acid (HCl) is generated.

There is a possibility that the strong acid aqueous solution such as sulfuric acid, nitric acid, and hydrochloric acid is held in contact with the exhaust contact portions of the exhaust system part, thereby resulting in corroding the exhaust contact portions.

Water splashed by the vehicle tends to adhere to the exposed portions of the exhaust system part. Therefore, there is a possibility that the exposed portions are corroded by the water adhering to the exposed portions.

Stainless steel with a high corrosion resistance has been widely used as a material of the exhaust system part in order to prevent corrosions of the exhaust contact portions and the exposed portions of the exhaust system part. The stainless steel has an oxide film consisting of a chromium oxide film (CrOₓ film) on its surface. Therefore, the corrosion resistance of the stainless steel has become high by the oxide film on the surface thereof.

The oxide film on the stainless steel has a high corrosion resistance against oxidizing acids such as nitric acid. However, the oxide film on the stainless steel has no high corrosion resistance against the sulfuric acid, the hydrochloric acid, and the like.

In order to improve the corrosion resistance even against non-oxidizing acid such as sulfuric acid and hydrochloric acid, the EGR cooler constructed to have a neutralizing agent layer consisting of calcium carbonate (CaCO₃) at the exhaust contact portions of the EGR cooler has been known (see, for example, Patent Document 1). According to this construction of the EGR cooler, the neutralizing agent layer of the EGR cooler can neutralize the sulfuric acid and the hydrochloric acid when the sulfuric acid and the hydrochloric acid are generated at the exhaust contact portions.

### CITATION LIST

### Patent Literature

### {Patent Document 1}

Japanese Patent Application Publication No. 2010-101239

### SUMMARY OF INVENTION

### Technical Problems

However, the exhaust system part having a neutralizing agent layer consisting of calcium carbonate as described above can neutralize the hydrochloric acid of low concentration to some extent by the neutralizing agent layer, but it has been difficult for the exhaust system part to sufficiently neutralize the hydrochloric acid of high concentration. Therefore, there has been such a problem that the exhaust contact portions are possible to be corroded when the hydrochloric acid of high concentration is generated at the exhaust contact portions of the EGR cooler.

The present invention has been made to solve such conventional problems as previously mentioned. It is therefore an object of the present invention to provide an exhaust system part having a high corrosion resistance, an EGR cooler using the exhaust system part, and a method of nitriding the exhaust system part.

### Solution to Problem

In order to solve the above problems, an exhaust system part according to the present invention, that allows an exhaust gas exhausted from an internal combustion engine to flow therein, comprising: an upstream side end portion through which the exhaust gas is introduced, a downstream side end portion through which the exhaust gas is discharged, and a wall portion formed in an annular shape extending in the direction of the exhaust gas flow and disposed between the upstream side end portion and the downstream side end portion, the upstream side end portion, the downstream side end portion, and the wall portion being made of stainless steel, the wall portion having an inner peripheral surface layer covered by a chromium oxide nitride film consisting of CrOₓN_{y} (“x” and “y” are any numbers, hereinafter the same).

By the construction of the exhaust system part as set forth in the above definition, the chromium oxide nitride film is formed on the surface layer of the inner peripheral side of the wall portion. For this reason, the coated film consisting of the chromium oxide nitride film stronger than a passivation film consisting of the oxide film formed on the surface layer of a conventional stainless steel is formed on the surface layer of the inner peripheral side of the wall portion. Therefore, the corrosion resistance of the inner peripheral side of the wall portion of the exhaust system part is improved. As a result, the wall portion can be suppressed from being corroded even if the inner peripheral side of the wall portion is exposed to the hydrochloric acid of high concentration.

Nitrogen is dissolved from the chromium oxide nitride film into an acidic aqueous solution adhering to the inner peripheral side of the wall portion. The nitrogen is combined with hydrogen to generate ammonium ion in the acidic aqueous solution. The hydrogen is used for the generation of ammonium ion so that the hydrogen ion concentration in the acidic aqueous solution is decreased. As a result, the corrosion by the acidic aqueous solution at the wall portion of the exhaust system part can be suppressed.

In the exhaust system part as set forth in the above definition, the chromium oxide nitride film is preferably formed to cover the entire area of the inner peripheral surface layer with which the exhaust gas is contacted.

By the construction of the exhaust system part as set forth in the above definition, the coated film consisting of the chromium oxide nitride film is formed to cover the entire area of the wall portion to which the acidic aqueous solution possibly adheres with the exhaust gas contacted to the entire area. As a result, the entire area of the wall portion is suppressed from being corroded by the acidic aqueous solution.

In the exhaust system part as set forth in the above definitions, the chromium oxide nitride film is formed with the inner peripheral surface layer being subjected to a nitriding treatment, the nitriding treatment being preferably carried out by the steps of removing an oxide film preliminarily formed on the inner peripheral surface layer, and adding nitrogen to the inner peripheral surface layer to react the inner peripheral surface layer with the nitrogen.

By the construction of the exhaust system part as set forth in the above definition, the coated film consisting of the chromium oxide nitride film stronger than the passivation film consisting of the chromium oxide film formed on the surface layer of the conventional stainless steel is formed on the surface layer of the inner peripheral side of the wall portion. As a result, the wall portion can be suppressed from being corroded even if the inner peripheral side of the wall portion is exposed to the hydrochloric acid of high concentration.

In the exhaust system part as set forth in any one of the above definitions, the chromium oxide nitride film preferably has a capability to elute its nitrogen to an acidic aqueous solution adhering to the chromium oxide nitride film, and to generate ammonium ion by having nitrogen combined with hydrogen in the acidic aqueous solution to decrease the hydrogen ion concentration in the acidic aqueous solution. By the construction of the exhaust system part as set forth in the above definition, the chromium oxide nitride film can decrease hydrogen ion concentration in the acidic aqueous solution. As a result, the corrosion by the acidic aqueous solution at the wall portion of the exhaust system part can be weakened.

An EGR cooler according to the present invention, comprising: a case, a cooling medium introduction pipe through which a cooling medium is introduced, a cooling medium discharge pipe through which the cooling medium is discharged, an exhaust gas cooling pipe constituted by at least one pipe accommodated in the case to allow the exhaust gas of the internal combustion engine to flow therein to cool the exhaust gas by heat exchange between the exhaust gas and the cooling medium flowing outside of the pipe, an exhaust gas introduction pipe connected to an upstream side end portion of the exhaust gas cooling pipe in the exhaust gas flow direction outside of the case, and an exhaust gas discharge pipe connected to a downstream side end portion of the exhaust gas cooling pipe in the exhaust gas flow direction outside of the case to supply the exhaust gas cooled by the exhaust gas cooling pipe to a suction apparatus of the internal combustion engine, in which at least any one of the exhaust gas cooling pipe, the exhaust gas introduction pipe, and the exhaust gas discharge pipe is constituted by the exhaust system part as set forth in any one of the above definitions.

By the construction of the exhaust system part as set forth in the above definition, the chromium oxide nitride film is formed on the surface layer of the inner peripheral side of the wall portion of at least any one of the exhaust gas cooling pipe, the exhaust gas introduction pipe, and the exhaust gas discharge pipe of the EGR cooler assumed to be the exhaust system part according to the present invention. For this reason, the corrosion resistance of the inner peripheral side of the wall portion of the exhaust system part having the coated film is improved. As a result, the corrosion of the wall portion can be suppressed even if the inner peripheral side of the wall portion is exposed to the hydrochloric acid of high concentration.

Moreover, the nitrogen is dissolved from the chromium oxide nitride film to the acidic aqueous solution adhering to the inner peripheral side of the wall portion of at least any one of the exhaust gas cooling pipe, the exhaust gas introduction pipe, and the exhaust gas discharge pipe of the EGR cooler assumed to be the exhaust system part according to the present invention. The nitrogen is combined with hydrogen to generate ammonium ion in the acidic aqueous solution. The hydrogen is used for the generation of ammonium ion so that the hydrogen ion concentration in the acidic aqueous solution is decreased. As a result, the corrosion by the acidic aqueous solution at the wall portion of the exhaust system part can be weakened.

A method of nitriding the exhaust system part, the exhaust system part that allows an exhaust gas exhausted from an internal combustion engine to flow therein, comprising: an upstream side end portion through which the exhaust gas is introduced, a downstream side end portion through which the exhaust gas is discharged, and a wall portion formed in an annular shape and disposed between the upstream side end portion and the downstream side end portion to extend in the exhaust gas flow direction, the upstream side end portion, the downstream side end portion, and the wall portion being made of stainless steel, the method of nitriding the inner peripheral surface layer of the wall portion of the exhaust system part comprising: a film removal process of removing an oxide film formed in advance on the inner peripheral surface layer, a heating process of adding nitrogen to the inner peripheral surface layer by raising the temperature of the exhaust system part placed in a closed space filled with a nitriding gas, a uniform heating hold process of holding uniform heating of the exhaust system part for a predetermined period of time to react the nitrogen and the inner peripheral surface layer, thereby forming the chromium oxide nitride film consisting of CrOₓN_{y} film on the inner peripheral surface layer, and a cooling process of cooling the exhaust system part.

By the construction of the method of nitriding the exhaust system part as set forth in the above definition, the chromium oxide nitride film is adapted to be formed on the surface layer of the wall portion by the treatment of the film removal process, the heating process, the uniform heating hold process, and the cooling process.

Moreover, the coated film consisting of chromium oxide nitride film stronger than the passivation film consisting of the chromium oxide film formed on the surface layer of the conventional stainless steel can be formed on the surface layer of the inner peripheral side of the wall portion. As a result, the wall portion can be suppressed from being corroded even if the inner peripheral side of the wall portion is exposed to the hydrochloric acid of high concentration.

### Advantageous Effects of Invention

The present invention can provide an exhaust system part, an EGR cooler using the exhaust system part, and a method of nitriding the exhaust system part. The exhaust system part is improved in corrosion resistance with its inner peripheral surface layer covered by a chromium oxide nitride film, resulting from the inner peripheral surface layer of the wall portion of the exhaust system part being subjected to the nitriding treatment.

### BRIEF DESCRIPTION OF DRAWINGS

FIG. 1 is a vertical cross-sectional view showing an EGR cooler according to an embodiment of the present invention.

FIG. 2 is a flow chart showing a procedure of the method of nitriding the exhaust system part according to the embodiment of the present invention.

FIG. 3 is a graph showing the relationship between processing time and temperature when the surface layers of the inner peripheral sides of the wall portions of the exhaust gas cooling pipes of the EGR cooler according to the embodiment of the present invention are subjected to a nitriding treatment performed by a plasma nitridation method.

FIG. 4 is a graph showing the relationship between the number of cycles and the maximum corrosion depth for the corrosion resistance tests in the examples of the exhaust system part according to the embodiment of the present invention and comparative examples of the exhaust system part.

### DESCRIPTION OF EMBODIMENTS

The embodiment of the exhaust system part according to the present invention will be described hereinafter with reference to the accompanying drawings. The present embodiment shows examples that the exhaust system part according to the present invention is applied to an EGR cooler of an automobile.

First, the construction of the EGR cooler 1 according to the present embodiment will be explained hereinafter.

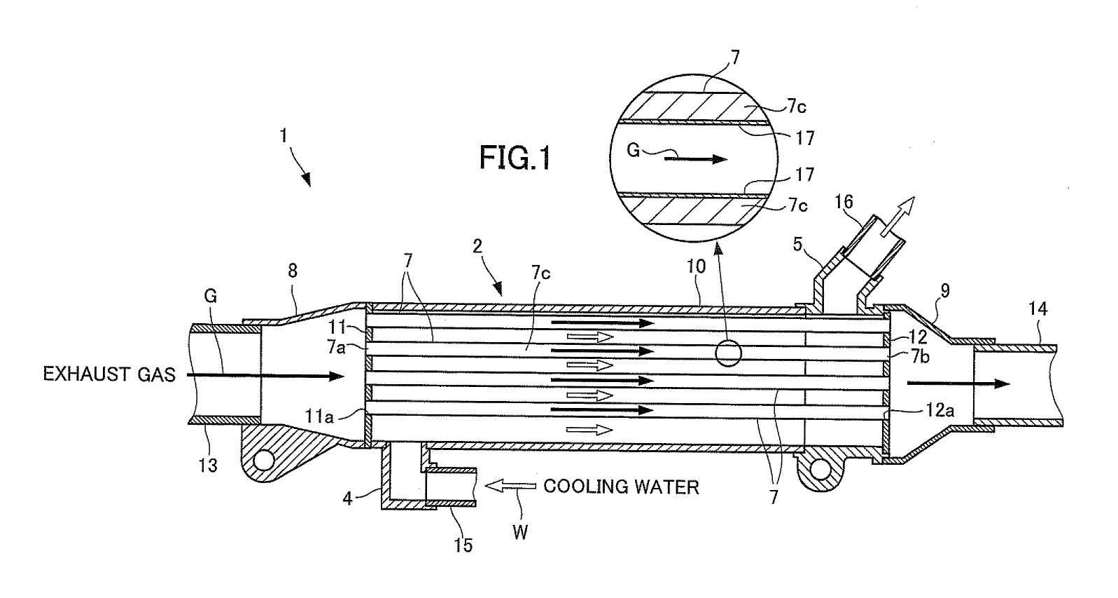

As shown in FIG. 1, the EGR cooler 1 is provided with a case 2, a cooling medium introduction pipe 4, a cooling medium discharge pipe 5, a plurality of exhaust gas cooling pipes 7 each serving as the exhaust system part, an exhaust gas introduction pipe 8, and an exhaust gas discharge pipe 9. Cooling water for an engine is used as a cooling medium W.

The case 2 is provided with a substantially cylindrical case body 10, an upstream side support plate 11, and a downstream side support plate 12. The cooling medium W flows along the axial direction in the case body 10.

The upstream side support plate 11 is provided at the upstream end portion of the case body 10 in the flow direction of the cooling medium W so as to close the upstream end portion. The upstream side support plate 11 has a plurality of through bores 11a formed therein.

The downstream side support plate 12 is provided at the downstream end portion of the case body 10 in the flow direction of the cooling medium W so as to close the downstream end portion. The downstream side support plate 12 has a plurality of through bores 12a.

The through bores 11a of the upstream side support plate 11 and the through bores 12a of the downstream side support plate 12 are equal in number, and provided at the respective positions facing each other across the case body 10. Each of the exhaust gas cooling pipes 7 is supported by a pair of through bores 11a, 12a facing each other of the respective upstream/downstream side support plates 11, 12.

The cooling medium introduction pipe 4 is provided in the vicinity of the upstream end portion of the case body 10 in the flow direction of the cooling medium W. The cooling medium introduction pipe 4 is adapted to flow the cooling medium W to the case 2.

The upstream side end portion of the cooling medium introduction pipe 4 is connected to a cooling medium supply pipe 15. The upstream side end portion of the cooling medium supply pipe 15 is connected to a supply pump (not shown) of the cooling medium W.

The cooling medium discharge pipe 5 is provided in the vicinity of the downstream end portion of the case body 10 in the flow direction of the cooling medium W. The cooling medium discharge pipe 5 is adapted to discharge the cooling medium W from the case 2.

The downstream side end portion of the cooling medium discharge pipe 5 is connected to a cooling medium discharge pipe 16. The downstream side end portion of the cooling medium discharge pipe 16 is connected to a water jacket (not shown) of the engine.

The exhaust gas cooling pipe 7 is made of stainless steel, and has an upstream side end portion 7a, a downstream side end portion 7b, and a wall portion 7c. The exhaust gas cooling pipe 7 is adapted to allow an exhaust gas G to flow therethrough.

The upstream side end portion 7a is pressed into the through bore 11a of the upstream side support plate 11 and supported by the upstream side support plate 11. The exhaust gas G is supplied to the upstream side end portion 7a through the exhaust gas introduction pipe 8. The downstream side end portion 7b is pressed into the through bore 12a of the downstream side support plate 12 and supported by the downstream side support plate 12. The exhaust gas G is discharged to the exhaust gas discharge pipe 9 through the downstream side end portion 7b.

The wall portion 7c is formed in an annular shape extending in the flow direction of the exhaust gas G and is provided between the upstream side end portion 7a and the downstream side end portion 7b. The entire area of the surface layer of the inner peripheral side of the wall portion 7c is subjected to the nitriding treatment. The entire area of the surface layer of the inner peripheral side of the wall portion 7c is therefore formed thereon a chromium oxide nitride film 17. The exhaust gas G flowing inside of the exhaust gas cooling pipe 7 is cooled by heat exchange with the cooling medium W flowing outside of the exhaust gas cooling pipe 7.

The exhaust gas introduction pipe 8 is provided at the upstream end portion of the case body 10 in the flow direction of the exhaust gas G, and connected to the exhaust gas cooling pipe 7. The upstream side end portion of the exhaust gas introduction pipe 8 is connected to an EGR gas supply pipe 13. The upstream side end portion of the EGR gas supply pipe 13 is connected to the exhaust apparatus (not shown).

The exhaust gas discharge pipe 9 is provided at the downstream end portion of the case body 10 in the flow direction of the exhaust gas G, and connected to the exhaust gas cooling pipe 7. The downstream side end portion of the exhaust gas discharge pipe 9 is connected to an EGR gas discharge pipe 14. The downstream side end portion of the EGR gas discharge pipe 14 is connected to the suction apparatus (not shown).

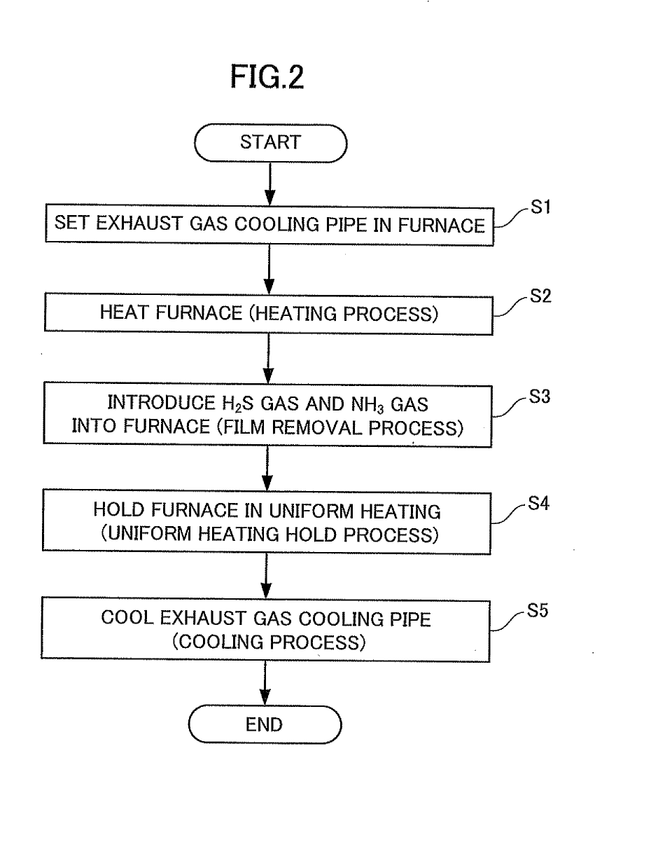

Next, a procedure of forming the chromium oxide nitride film 17 on the surface layer of the inner peripheral side of the wall portion 7c of the exhaust gas cooling pipe 7 by the method of nitriding the exhaust system part according to the embodiment of the present invention, will be explained with reference to the flow chart shown in FIG. 2.

The method of nitriding the exhaust system part includes a preparation process, a heating process, a film removal process, a uniform heating hold process, and the cooling process, and these processes will be performed in this order in a same vacuum furnace. In the present embodiment, the chromium oxide nitride film 17 will be formed on the surface layer of the inner peripheral side of the wall portion 7c of the exhaust gas cooling pipe 7 by a gas nitridation method.

First, as the preparation process, a cover made of mild steel plate is attached to an outer peripheral side of the exhaust gas cooling pipe 7 to prevent nitridation. The exhaust gas cooling pipe 7 is placed in the furnace (step S1).

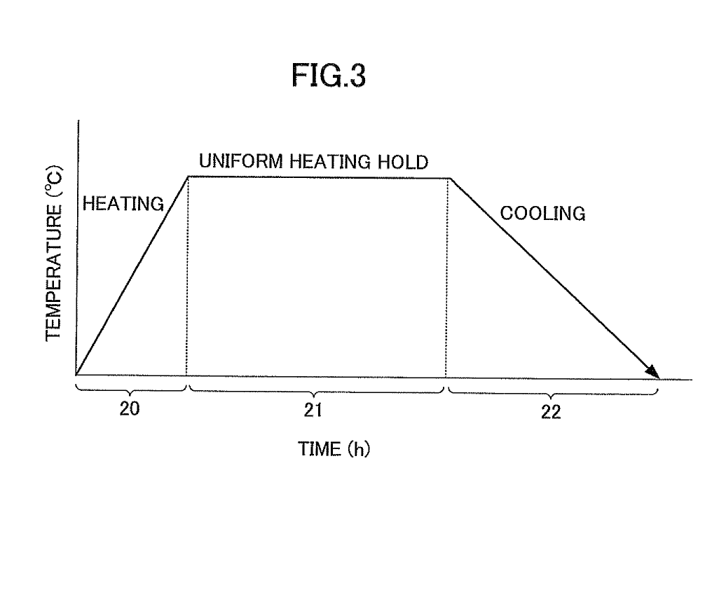

As the heating process, the furnace is heated up to 570° C. at a relatively rapid speed (step S2, reference numeral 20 in FIG. 3). Thus, the exhaust gas cooling pipe 7 and the furnace atmosphere are heated. Subsequently, a mixture gas essentially consisting of hydrogen sulfide (H₂S) gas and ammonia (NH₃) gas is introduced into the furnace (step S3).

The hydrogen sulfide gas reacts with the oxide film mainly containing the chromium oxide (CrOₓ) formed in advance on the surface layer of the exhaust gas cooling pipe 7 to remove the oxide film (film removal process). A part of chromium and oxygen forming the chromium oxide film remains on the surface layer of the wall portion 7c after the oxide film is removed.

In the present embodiment, the hydrogen sulfide gas is used in the film removal process, but any gas capable of removing the oxide film may be used in lieu of the hydrogen sulfide gas. Moreover, in the present embodiment, the film removal process by introducing the hydrogen sulfide gas and the ammonia gas into the furnace is performed after the beginning of the heating process, however, may not be limited to this order according to the present invention. The film removal process may be started at the same time with the heating process after the hydrogen sulfide gas and the ammonia gas are introduced into the furnace according to the present invention.

Subsequently, the furnace is maintained at 570° C. for 8 hours (reference numeral 21 in FIG. 3). Thus, the exhaust gas cooling pipe 7 and the furnace atmosphere are held in uniform heating (uniform heating hold process).

In the heating process and the uniform heating hold process, a part of the ammonium gas in the furnace atmosphere is decomposed into nitrogen and the hydrogen. Nitrogen atoms in the furnace atmosphere are penetrated into the surface layer of the wall portion 7c of the exhaust gas cooling pipe 7 by heating the exhaust gas cooling pipe 7. The nitrogen penetrated into the surface layer is combined with the chromium partly constituting a component of the stainless steel and the oxygen forming the oxide film, thereby generating the chromium oxide nitride on the surface layer. As a result, the chromium oxide nitride film 17 is formed on the surface layer of the inner peripheral side of the wall portion 7c.

After the uniform heating hold process, the exhaust gas cooling pipe 7 is relatively slowly cooled to about the room temperature (cooling process).

Next, the operation of the EGR cooler 1 will be explained hereinafter.

The exhaust gas G is supplied to the EGR cooler 1 from the exhaust apparatus of the engine through the EGR gas supply pipe 13. The exhaust gas G flows in the exhaust gas introduction pipe 8, the exhaust gas cooling pipe 7, and the exhaust gas discharge pipe 9 in this order in the EGR cooler 1. The exhaust gas G discharged from the EGR cooler 1 is supplied to the suction apparatus of the engine through the EGR gas discharge pipe 14.

The cooling medium W is supplied to the EGR cooler 1 from the supply pump through the cooling medium supply pipe 15. The cooling medium W flows in the cooling medium introduction pipe 4, the case body 10, and the cooling medium discharge pipe 5 in this order in the EGR cooler 1. The cooling medium W discharged from the EGR cooler 1 is supplied to the water jacket of the engine through the cooling medium discharge pipe 16.

The exhaust gas G flowing inside of the exhaust gas cooling pipe 7 is cooled by heat exchange with the cooling medium W flowing outside of the exhaust gas cooling pipe 7. The water vapor contained in the exhaust gas G is at this time condensed to become water drops on the chromium oxide nitride film 17 formed on the surface layer of the inner peripheral side of the exhaust gas cooling pipe 7.

The sulfurous acid gas, the nitrogen oxide gas, and the chlorine gas are dissolved in the water drops to generate the sulfuric acid, the nitric acid, the hydrochloric acid, and other acids. The chromium oxide nitride film 17 has a high corrosion resistance against the sulfuric acid, the nitric acid, the hydrochloric acid, and other acids. For this reason, the wall portion 7c of the exhaust gas cooling pipe 7 is suppressed from being corroded.

The nitrogen is dissolved and eluted from the chromium oxide nitride film 17 to the acidic aqueous solution adhering to the inner peripheral side of the wall portion 7c of the exhaust gas cooling pipe 7. The nitrogen is combined with hydrogen to generate ammonium ion in the acidic aqueous solution. Since the hydrogen in the acidic aqueous solution is used for the generation of ammonium ion, the hydrogen ion concentration of the acidic aqueous solution in the exhaust gas cooling pipe 7 is decreased.

As described above, the EGR cooler 1 according to the embodiment of the present invention is constructed to have the exhaust gas cooling pipe 7 having the surface layer of the inner peripheral side of the wall portion 7c formed with the chromium oxide nitride film 17. For this reason, the corrosion resistance of the wall portion 7c of the exhaust gas cooling pipe 7 is improved. As a result, the corrosion of the wall portion 7c can be suppressed even if the inner peripheral side of the wall portion 7c is exposed to the strong hydrochloric acid.

The gas nitridation method is employed to form the chromium oxide nitride film 17 on the wall portion 7c of the exhaust gas cooling pipe 7, so that the exhaust system part can be easily constructed as compared to other nitridation methods. This makes it possible to suppress an increase in production cost for the exhaust system part.

In the EGR cooler 1 of the present embodiment described above, the chromium oxide nitride film 17 is formed on the inner peripheral side of the wall portion 7c of the exhaust gas cooling pipe 7, however, the present invention is not limited to this construction. The EGR cooler according to the present invention may have, for example, the chromium oxide nitride film formed on the inner peripheral side of the wall portion of the exhaust gas introduction pipe 8 or the exhaust gas discharge pipe 9 in addition to the chromium oxide nitride film 17 formed on the inner peripheral side of the wall portion 7c of the exhaust gas cooling pipe 7.

In this construction, the chromium oxide nitride film can be formed, for example, on the wall portions of the exhaust gas cooling pipe 7, the exhaust gas introduction pipe 8, and the exhaust gas discharge pipe 9, or otherwise only on the wall portions of the exhaust gas cooling pipe 7, and the exhaust gas discharge pipe 9. Moreover, the EGR cooler according to the present invention may have the chromium oxide nitride film formed on the wall portion of members other than the exhaust gas cooling pipe 7, the exhaust gas introduction pipe 8, and the exhaust gas discharge pipe 9.

In the EGR cooler 1 according to the present embodiment described above, the chromium oxide nitride film 17 is formed on the entire area of the surface layer of the inner peripheral side of the wall portion 7c of the exhaust gas cooling pipe 7, however, the present invention is not limited to this construction. The EGR cooler according to the present invention may have the chromium oxide nitride film 17 formed, for example, on only a part of the surface layer of the inner peripheral side of the wall portion 7c of the exhaust gas cooling pipe 7.

In the EGR cooler 1 of the present embodiment described above, the uniform heating hold temperature is 570° C. and the uniform heating hold time is 8 hours in the uniform heating hold process, however, the present invention is not limited to these conditions. The EGR cooler according to the present invention may have the uniform heating hold temperature set, for example, at 300° C. to 590° C., and the uniform heating hold time set, for example, in 6 hours to 10 hours. In these conditions, the higher the uniform heating hold temperature is, the shorter the uniform heating hold time can be.

In the EGR cooler 1 of the present embodiment described above, the gas nitridation method is adopted to form the chromium oxide nitride film 17, however, the present invention is not limited to this nitridation method. The EGR cooler according to the present invention may adopt other nitridation method, for example, such as a plasma nitridation method, a salt bath nitridation method, a gas soft nitridation method, and other nitridation methods.

In the exhaust system part of the present embodiment described above, the exhaust system part is applied to the EGR cooler 1, however, the present invention is not limited to the EGR cooler 1. The exhaust system part according to the present invention may apply the exhaust system part to a general part, for example, such as an exhaust gas manifold, an exhaust gas pipe, and the like constituting the exhaust apparatus.

As described above, the exhaust system part and the EGR cooler using the exhaust system part according to the present invention are useful in general when the improved corrosion resistance is needed.

### EXAMPLES

A corrosion resistance test was conducted with a sample of stainless steel (SUS316L) having the surface layer subjected to various kinds of nitriding treatments. In the corrosion resistance test, the sample is immersed and heated in mixed solution of sulfuric acid and hydrochloric acid, and dried, and then moistened. This process is one cycle for the corrosion resistance test.

The maximum corrosion depth in the surface layer of the sample was measured at the end of the 10 cycles and/or 20 cycles of the processes. The maximum corrosion depth is set along with the reference value set at 1.0 as a measured value of Comparative Example 1, and the measured values of the other examples are shown converted with no unit as the ratio of the reference value.

### Example 1

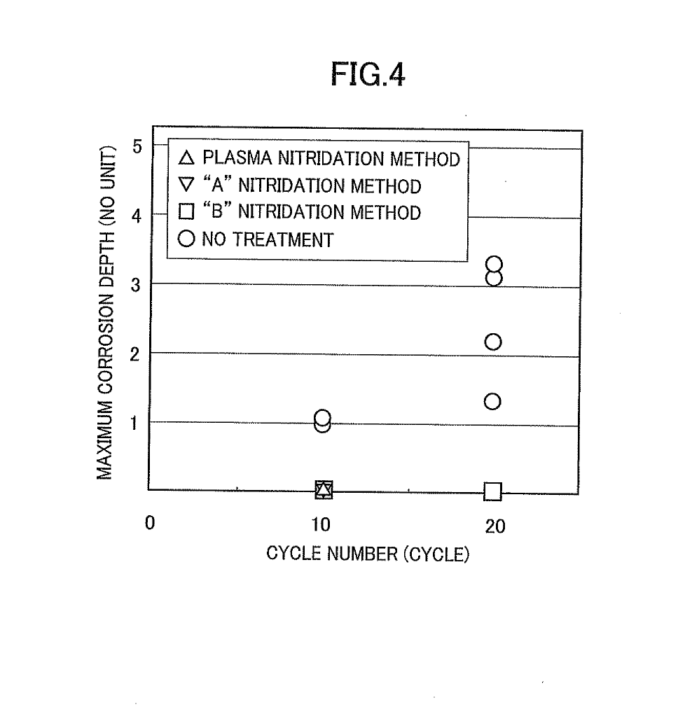

A sample was subjected to the nitriding treatment by the plasma nitridation method. The treatment atmosphere was nitrogen gas and hydrogen gas. The heating temperature was 570° C. The uniform heating hold time was 4 hours. The corrosion resistance test was conducted 10 cycles for the sample. The corrosion resistance test results find that the maximum corrosion depth in the surface layer of the sample was 0.0 as shown in FIG. 4.

### Example 2

A sample was subjected to the nitriding treatment by “A” nitridation method. The treatment atmosphere was in general nitriding treatment gas. The heating temperature was from 500° C. to 600° C. The uniform heating hold time was from 1 hour to 3 hours. The corrosion resistance test was conducted 10 cycles and 20 cycles for the sample. The corrosion resistance test results find that the maximum corrosion depth in the surface layer of the sample was 0.0 in either case as shown in FIG. 4.

### Example 3

A sample was subjected to the nitriding treatment by “B” nitridation method. The treatment atmosphere was in general nitriding treatment gas. The heating temperature was from 350° C. to 450° C. The uniform heating hold time was from 40 hours to 60 hours. The corrosion resistance test was conducted 10 cycles for the sample. The corrosion resistance test results find that the maximum corrosion depth in the surface layer of the sample was 0.0 as shown in FIG. 4.

### Comparative Example 1

A sample was not subjected to the nitriding treatment. The corrosion resistance test was conducted 10 cycles for the sample. The corrosion resistance test results find that the maximum corrosion depth in the surface layer of the sample was 1.0 as shown in FIG. 4.

### Comparative Example 2

A sample was not subjected to the nitriding treatment. The corrosion resistance test was conducted 10 cycles for the sample. The corrosion resistance test results find that the maximum corrosion depth in the surface layer of the sample was 1.1 as shown in FIG. 4.

### Comparative Example 3

A sample was not subjected to the nitriding treatment. The corrosion resistance test was conducted 20 cycles for the sample. The corrosion resistance test results find that the maximum corrosion depth in the surface layer of the sample was 1.4 as shown in FIG. 4.

### Comparative Example 4

A sample was not subjected to the nitriding treatment. The corrosion resistance test was conducted 20 cycles for the sample. The corrosion resistance test results find that the maximum corrosion depth in the surface layer of the sample was 2.2 as shown in FIG. 4.

### Comparative Example 5

A sample was not subjected to the nitriding treatment. The corrosion resistance test was conducted 20 cycles for the sample. The corrosion resistance test results find that the maximum corrosion depth in the surface layer of the sample was 3.1 as shown in FIG. 4.

### Comparative Example 6

A sample was not subjected to the nitriding treatment. The corrosion resistance test was conducted 20 cycles for the sample. The corrosion resistance test results find that the maximum corrosion depth in the surface layer of the sample was 3.4 as shown in FIG. 4.

As will be understood from the above examples, the corrosion was not observed in 20 or less cycles of the corrosion resistance test for the samples subjected to the nitriding treatment, and the samples was confirmed to have a high corrosion resistance as compared with the samples not subjected to the nitriding treatment.

### REFERENCE SIGNS LIST

1: EGR cooler
2: case
4: cooling medium introduction pipe
5: cooling medium discharge pipe
7: exhaust gas cooling pipe (exhaust system part)
8: exhaust gas introduction pipe
9: exhaust gas discharge pipe
17: chromium oxide nitride film
G: exhaust gas
W: cooling medium
S2: heating process
S3: film removal process
S4: uniform heating hold process
S5: cooling process

1. An exhaust system part that allows an exhaust gas exhausted from an internal combustion engine to flow therein, comprising:
an upstream side end portion through which the exhaust gas is introduced,
a downstream side end portion through which the exhaust gas is discharged, and
a wall portion formed in an annular shape and disposed between the upstream side end portion and the downstream side end portion to extend in the exhaust gas flow direction,
the upstream side end portion, the downstream side end portion, and the wall portion being made of stainless steel,
the wall portion having an inner peripheral surface layer covered by a chromium oxide nitride film consisting of CrOₓN_{y}.

2. The exhaust system part as set forth in claim 1, in which the chromium oxide nitride film is formed to cover the entire area of the inner peripheral surface layer with which the exhaust gas is contacted.

3. The exhaust system part as set forth in claim 1, in which the chromium oxide nitride film is formed with the inner peripheral surface layer being subjected to a nitriding treatment, the nitriding treatment being carried out by the steps of removing an oxide film preliminarily formed on the inner peripheral surface layer, and adding nitrogen to the inner peripheral surface layer to react the inner peripheral surface layer with the nitrogen.

4. The exhaust system part as set forth in claim 1, in which the chromium oxide nitride film has a capability to elute its nitrogen to an acidic aqueous solution adhering to the chromium oxide nitride film, and to generate ammonium ion by having nitrogen combined with hydrogen in the acidic aqueous solution to decrease hydrogen ion concentration in the acidic aqueous solution.

5. An EGR cooler, comprising:
a case,
a cooling medium introduction pipe through which a cooling medium is introduced,
a cooling medium discharge pipe through which the cooling medium is discharged,
an exhaust gas cooling pipe constituted by at least one pipe accommodated in the case to allow the exhaust gas of the internal combustion engine to flow therein to cool the exhaust gas by heat exchange between the exhaust gas and the cooling medium flowing outside of the pipe,
an exhaust gas introduction pipe connected to an upstream side end portion of the exhaust gas cooling pipe in the exhaust gas flow direction outside of the case, and
an exhaust gas discharge pipe connected to a downstream side end portion of the exhaust gas cooling pipe in the exhaust gas flow direction outside of the case to supply the exhaust gas cooled by the exhaust gas cooling pipe to a suction unit of the internal combustion engine, in which
at least any one of the exhaust gas cooling pipe, the exhaust gas introduction pipe, and the exhaust gas discharge pipe is constituted by the exhaust system part as set forth in claim 1.

6. A method of nitriding an exhaust system part,
the exhaust system part that allows an exhaust gas exhausted from an internal combustion engine to flow therein, comprising:
an upstream side end portion through which the exhaust gas is introduced,
a downstream side end portion through which the exhaust gas is discharged, and
a wall portion formed in an annular shape and disposed between the upstream side end portion and the downstream side end portion to extend in the exhaust gas flow direction,
the upstream side end portion, the downstream side end portion, and the wall portion being made of stainless steel,
the method of nitriding the inner peripheral surface layer of the wall portion of the exhaust system part comprising:
a film removal process of removing an oxide film formed in advance on the inner peripheral surface layer,
a heating process of adding nitrogen to the inner peripheral surface layer by raising the temperature of the exhaust system part placed in a closed space filled with a nitriding gas,
a uniform heating hold process of holding uniform heating of the exhaust system part for a predetermined period of time to react the nitrogen and the inner peripheral surface layer, thereby forming the chromium oxide nitride film consisting of CrOₓN_{y} film on the inner peripheral surface layer, and
a cooling process of cooling the exhaust system part.
